(19) United States
(12) Patent Application Publication
(10) Pub. No.: US 2005/0216830 A1
(43) Pub. Date: Sep. 29, 2005

(54) Access tool to facilitate exchange of data to and from an end-user application software package

(76) Inventors: Jeffrey Scott Turner, Raleigh, NC (US); Lafayette Thompson JR., Cary, NC (US); Tommy Ray Willard, Cary, NC (US)

Correspondence Address: THE ECLIPSE GROUP, 10453 RAINTREE LANE, NORTHRIDGE, CA, 91326, US

(21) Appl. No.: 10/811,650

(22) Filed: Mar. 29, 2004

(51) Int. Cl. G06F 17/00

(52) U.S. Cl. 715/513; 707/1

(57) ABSTRACT

An access tool to facilitate exchange of data to and from an end-user application to one or more corporate data files without the end-user's direct use of the corporate data tool used to create and maintain the corporate data files. The process works without the need of the end-user to be familiar with the particular corporate data tool (such as SQL) or how to connect to the one or more corporate data files (such as a database). An end-user document template with one or more variable tags is used as a placeholder for a set of one or more queries that are executed against one or more the corporate data files (such as one or more databases). After execution of the one or more queries against the one or more corporate data files, the values obtained from the queries are formatted and placed back into the template document in place of the corresponding variable tags. Another optional feature of the present invention is the use creation of data entry forms based on templates with appropriately placed variable tags. The form template created by the end-user using an end-user tool. This abstract is provided as a tool for those searching for patents, and not as a limitation on the scope of the claims.

### BACKGROUND OF THE INVENTION

1. Technical Field

The present invention is in the field of computer programming. More particularly, this invention is in the field of document generation tools that access stored values of one or more variables. The term document is intended to encompass the concepts of printed documents as well as documents intended to be viewed over a computer display such as but not limited to a web page intended to be viewed through a network browser. The present invention can also be used to input data from an end-user created form into a corporate data file such as a data base.

2. Description of Prior Art

The prior art includes a range of powerful tools that are used to store and retrieve values from data files such as data files that comprise a relational data base. One such program is known as SQL. Other examples include but are not limited to products such as SAS, Oracle, Enterprise Resource Planning packages such as SAP, Peoplesoft's products, various data mining tools, project management software, Customer Relationship Management software, and accounting packages. At the lower end of the range there are a series of programs that run on a personal computer such as Dbase, Excel, MS Access that are more complex than many other personal computer applications. A commonality of this wide assortment of computer software packages is that these tools are feature rich and require training in order to know the appropriate methods and syntax for using the tool. This tool specific knowledge is in addition to the skills necessary to efficiently reduce a set of data and associations into a schema or other organizational structure to efficiently store the data for the needs of the organization. In many organizations, it is difficult or impossible to get access to people with the appropriate skills in order to formulate special queries to the data base. For want of a better name, we can refer to these tools as “corporate data tools.” As shown in FIG. 1, a computer 104 is used to interface with a corporate data tool 108 to create, control, and access one or more corporate data files 112. The results of a query against one of these data files can be communicated to others by such means as a printer 116 that prints a standard report 120.

The prior art also includes a range of end-user tools that are used by end-users on a computer 130. These tools include by way of example, the various products of Microsoft such as Word (a word processing application 134), Excel (a spreadsheet application 142), Access (a tool used by some end-users for a user created data base), PowerPoint (an end-user tool for creating presentations 146), FrontPage (a tool used by some end-users to create web pages), and others. Note that within a small office, the main corporate data files may be created, controlled, and accessed through tools such as Access or Excel and less savvy end-users may not know how to use these programs. Thus, some programs typified by Access and Excel can be the end-user application in some contexts and in other contexts these same programs could play the role of the “powerful tools that are used to store and retrieve values from data files” discussed above in the section of corporate data tools 108 and are only understood by a small cadre of people.

There is often a need to write reports or create other documents (150, 154, and 158) using an end-user tool but including one or more data values (such as value X) from a corporate data file 112 created and maintained by a corporate data tool 108. One option is to run a preformatted standard report 120 using the corporate data tool 108 to obtain the relevant data values (such as value X) and then entering (such as by typing through a keyboard 146) the relevant values (such as value X) from the output report 120 based on the corporate data tool 108 into the document (150, 154, 158) created in the end-user tool (134, 138, and 142). This is not a perfect solution, especially if the output from the corporate data tool is less than current or is based on a date range other than the one to be used in the document being created in the end-user tool.

Other prior art solutions provided partial ability to integrate data stored in one program into a document to be created in another program. An example is Microsoft Mail Merge which allows the placement of “variables” into a Microsoft Word document for example the name, address, and account number for a series of customers to receive a form letter. Mail Merge works with ODBC data sources. (OBDC is an acronym for the Microsoft Open DataBase Connectivity standard.) A simple example would be a Microsoft Excel spreadsheet containing the relevant data in rows and columns with one row per account. Mail Merge allows the user to designate that the individual values from a column (name, address, account number) are to be placed at specific places in the form. The Mail Merge program will allow the creation of a set of form letters, one for each data row in the Excel table. To create a single form letter to a single account, one can use forward and back keys to advance a pointer in the spreadsheet to create form letters for the various rows of data and then printing the form letter with the data for the appropriate row. Mail Merge would not support the selection of a subset of rows based on selection criteria to receive a special form letter. The user would need to either toggle and print individual letters or execute selection criteria on the data side (in this case within the Excel program).

An analogous need exists with respect to the creation of on-line input forms. As end-users are often involved with the collection and input of data that becomes the values in the corporate data files, the end-users often have special insight into the best way to arrange an input form and what text is useful to have on the form for the purpose of an explanation, reminder, or warning. As the entry of data into corporate data files is handled by special corporate data tools and requires knowledge of file layouts and specific formats, the creation of online forms requires the end-users to obtain permission and priority to get scarce Information Technology team members to create the online form and make the links to the relevant files of corporate data. If the end-user later desired to tweak the form to better adjust the form to the task or to a temporary change in the task, the end-user had to get the attention and time of the Information Technology team again. Ironically, for small changes that would not take long to accomplish, the small change was perceived as having a small benefit and was placed low on the list of tasks for the Information Technology team.

Problems with Prior Art Solutions

The biggest problem with programs such as Mail Merge is its inability to combine multiple data sets into one document. The prior art tools do not allow the user to readily create tables of data using all rows of the result set returned in a query. The prior art tools do not allow the end-user to combine data from two or more sources into one document where a source is a particular combination of a query and data file (such as two or more query results from the same data file, the results from the same query run against two data files, or a first query run against a first data file and a second query run against a second data file).

The use of Mail Merge requires that the end-user a) knows where the database/data source is, b) can create an ODBC data source, c) is familiar with the database tables or columns, and d) has the proper drivers and components on the end-user's machine to access the database. Many and probably most of the end-users do not have necessary familiarity with databases or other corporate data tools and might not have the level of Information Technology knowledge required to access learn the required information to access the corporate data. While some end-users may have sufficient knowledge to link a Mail Merge to an Excel spreadsheet, exceedingly few true end-users could make the appropriate links to other OBDC data sources such as an Oracle data base that may be comprised of a series of tables.

In some instances the specific organization of the corporate data may not be communicated throughout the organization which adds further complications to accessing this data directly.

Another limitation with a product such as Mail Merge is it only addresses movement from the corporate data file to an end-user document. Products of this type will not take data inserted in an end-user document and update the corporate data file. Thus, a report created at one time of the month may need to have special values placed into the report. It will take a separate and redundant action for the special values to be sent to someone with access to load that information through the corporate data tool into the corporate data file.

A comparison between the capabilities of programs such as Mail Merge and the needs of end-users for a more powerful end-user tool is shown in Table 1.

TABLE1

| | Comprehensive | |
|---|---|---|
| | Needs for | |
| | a new | Mail |
| Feature | End-User Tool | Merge |
| Document creation with values from corporate | | |
| data file | | |
| Import data directly into Word or Excel | Yes | Yes |
| Format data WYSIWIG | Yes | Yes |
| Import data directly into other applications | Yes | No |
| supporting RTF or HTML | | |
| Import data from multiple data sources | Yes | No |
| Return multiple rows of data for individual | Yes | No |
| variables | | |
| Return multiple rows of data as a single | Yes | No |
| sentence with grammatical conjunction | | |
| Format rows of data into tables | Yes | No |
| Specify query conditions for individual | Yes | No |
| variables or tables | | |
| No knowledge of database tables or columns | Yes | No |
| required | | |
| No ODBC database drivers required | Yes | No |
| No knowledge of SQL or VBScript required | Yes | No |
| No knowledge of source database required | Yes | No |
| View document from anywhere on the web | Yes | No |
| Collection of corporate data values through | | |
| end-user document | | |
| Convert document into collection form | Yes | No |
| Publish document to the web for data collection | Yes | No |
| Data entered is saved directly into the database | Yes | No |
| Data validation on data entered into form | Yes | No |
| (dates, strings, numbers, field lengths, etc.) | | |

The prior art solutions included some corporate data tools that included ancillary report writing tools. While this was a partial solution, it forced end-users to learn not only the syntax to obtain the data in the corporate data tool but also to learn a new set of commands in order to obtain a report. Additionally, placing a limited report writing tool in the corporate data tool did not provide the full range of features offered by a suite of end-user tools that are used by virtually all end-users (word processing, spreadsheets, presentations graphics, et cetera).

It is an object of this present invention to provide a comprehensive new tool to allow end-users to work with corporate data without having to learn the corporate data tool or nuances of precisely how the corporate data is stored.

It is an object of this present invention to provide a tool that supports the placement of data from multiple data sets maintained by one or more corporate data tools within a single end-user created document.

It is an object of this present invention to provide a tool that allows the insertion of one or more sets of data based on a selection criteria that is provided outside of the corporate data tool that controls the corporate data file so that the end-user is freed from knowing the details of the file structure and the syntax of the corporate data tool.

It is an object of this present invention to provide a tool that allows for the creation of end-user documents with embedded values from one or more corporate data files without knowledge of ODBC drivers.

It is an object of this present invention to provide a tool that can be used to place values from a corporate data file into an end-user document and will allow the placement of data values from an end-user document into the corporate data file in order to avoid the inefficiency of having to load that data value through the corporate data tool after already using it in an end-user document.

It is an object of the present invention to allow end-users a variety of feature rich end-user tools that the end-user already knows in order to create and subsequently modify output documents such as reports (created in word processing applications), spreadsheets (created in spreadsheet applications), and presentations (created in presentation applications such as Microsoft PowerPoint).

It is an object of the present invention to provide end-users with a guide to the variables stored in a corporate data tool in a format that makes sense to the end-users rather than in the format accessible only to those programmers familiar with the data storage layout used for the corporate data.

It is an object of the present invention to leverage the efforts of Information Technology staff by collecting their work with respect to the attributes of various corporate data variables into an electronic format so that this repository of information can be accessed by an “access tool” to convert end-user requests for output reports and input templates into actual output report templates, generated output reports, and electronic input forms.

These and other advantages of the present invention are apparent from the drawings and the detailed description that follows.

### BRIEF SUMMARY OF DISCLOSURE

The present invention is directed to an access tool implemented in software that satisfies the previously unmet needs to allow end users to create input and output templates that can be converted to provide the necessary items to allow access to previously stored values in one or more corporate data files or to allow the creation of an online input form that conveys data into one or more corporate data files. The access tool provides the necessary material to provide this power to the end user without requiring the end user to learn the specifics of the corporate data file layouts or of the highly specialized corporate data software that is traditionally used exclusively by specialized Information Technology team members. The use of the access tool as configured for the specific types of corporate data files leverages the skills of the Information Technology team by removing the need for involvement in creating a wide range of output documents and online input forms.

The present invention avoids some of the limitations of the prior art by treating each variable or table to be inserted into an end-user document as a separate query. These queries (for example, SQL statements) are generated by software operated in accordance with the present invention the when the end-user requests that a particular document be generated. The process works without the need of the end-user to be familiar with the particular corporate data tool (such as SQL) or how to connect to the one or more corporate data files (such as a database). An end-user document template with one or more variable tags is used as a placeholder for a set of one or more queries that are executed against one or more the corporate data files (such as one or more databases). After execution of the one or more queries against the one or more corporate data files, the values obtained from the queries are formatted and placed back into the template document in place of the corresponding variable tags.

The present invention also allows end-users to build tables of data, returning multiple rows of data into neatly organized tables, with formats and column widths easily definable by the user. Another format for display of values obtained from corporate data files is “strings” comprised of multiple values which were independently stored in the corporate data file. These strings can be placed in the middle of context providing sentences within the generated document. The individual values in the string result can be separated by commas with an “AND” conjunction placed before the last item by the access tool without intervention from the end-user each time the document is generated. .

The attributes of the access tool is in contrast with programs such as Mail Merge, which while fairly easy to use, requires some knowledge of databases, ODBC or even SQL. In order to use such prior art tools the end-user needs to have direct access to the targeted database, either with an ODBC driver or other data access method, and must be familiar with the table and column names within the corporate data files.

The present invention abstracts this Information Technology “IT” layer by replacing the programmer's abbreviated names for values stored in one or more tables with user-friendly descriptions of the data variables. Optionally, these user-friendly descriptions can be grouped together into logical folders to make it easier for the end-user to locate variables of interest. This eliminates the need of the end-user to be familiar with how the corporate Information Technology team has configured and defined the databases and schema that hold the corporate data. In a preferred embodiment, the present invention operates on a server accessible to the end-user. In this embodiment the server implementing the present invention queries the database and thus the end-user does not need ODBC or other database drivers on the end- user's personal computer. The bridge between the user's knowledge of a user friendly name for a variable and the programmers view of the variable (variable type, table, column, et cetera) is provided by a collection of information manually created that is referenced below as the DMS meta table.

The present invention allows an end user to communicate a template of an input form, complete with variable tags to the access tool for creation of an electronic input form. The process of creating such as form can use the same DMS meta table files used for creating output documents as long as the meta table includes the information necessary to complete this task.

### BRIEF DESCRIPTION OF THE DRAWINGS

FIG. 1 is a representation of the prior art dichotomy between the corporate data file accessed by the corporate data tool and the end-user tools used to create documents that include values from one or more corporate data files.

FIG. 2 illustrates the division of the access tool function between a client module 204 and a server module 254.

FIG. 3 is a flow chart with the steps for an end-user to generate a document having embedded data values obtained from one or more corporate data files.

FIG. 4 is a flow chart that provides details for one implementation of the process for opening the DMS client 204.

FIG. 5 is a flow chart that provides details for one implementation of the process for opening the DMS server module.

FIG. 6 is a flow chart that provides details for an implementation of a drag/drop operation to insert a variable tag into a template.

FIG. 7 is a flow chart that provides an example of a sequence of acts to publish a template as seen at the DMS client.

FIG. 8 is a flow chart that provides an example of a sequence of acts to publish a template as seen at the DMS server side module.

FIG. 9 is a flow chart that provides details for the steps performed by the DMS client software to display to the user the available templates.

FIG. 10 is a flow chart that conveys the steps on the server side to support the display of the list of available templates.

FIG. 11 is a flow chart that illustrates one implementation of the steps for generating a document based on a specific template and set of one or more target data files.

FIG. 12 is one example of the layout of parameter attributes in a meta data table, used by the access tool to bridge the gulf between the end user's view of the corporate data and the Information Technology team's view of the corporate data.

FIG. 13 illustrates one implementation of the process for creating and using an input form 1350.

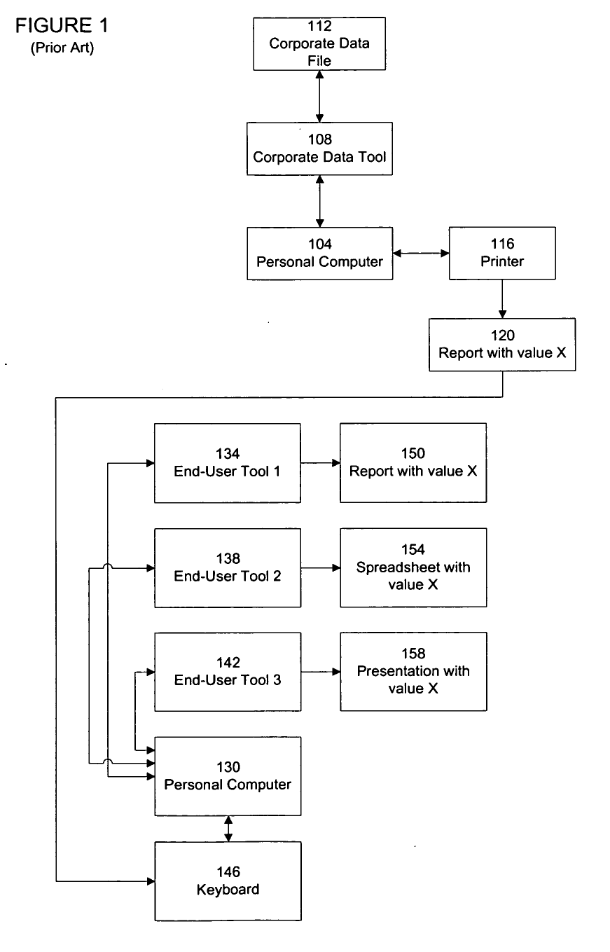

### DETAILED DESCRIPTION OF THE DISCLOSED EMBODIMENT

The present invention will now be described more fully hereinafter with reference to the accompanying drawings, in which preferred embodiments of the invention are shown.

An example of a preferred embodiment of the present invention is contained in a software solution offered by iAdvantage Software, Inc. of Cary N.C. in a package called DMS. Excerpts from the user instructions for this package are included in Appendix A attached to this document in order to provide additional examples of screen shots and implementation sequences for those having an interest in a specific implementation beyond the more generalized description provided below. While the details in the appendix are for a particular implementation for the combination of a SQL data base and Microsoft Word as the selected end-user tool, the concepts illustrated in the appendix can be applied by analogy to other data tool/end-user tool pairs.

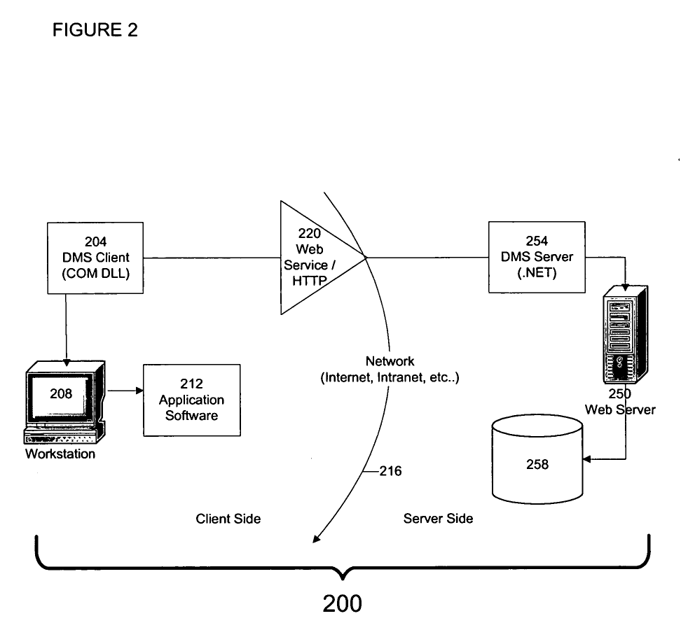

As illustrated in FIG. 2, in this preferred embodiment, the functionality of the DMS system 200 is broken into two components. The first component is a DMS client 204 operating on the end-user's client workstation 208. In this example, the end-user is working to create documents in particular end-user application software 212 which in this case is Microsoft Word.

The client workstation 208 is in contact with a network 216 through web service 220. Also connected to the network 216 is a web server 250 running the DMS Server software 254. The web server 250 is in data communication to a corporate data file 258 such as a corporate data base. The DMS server component can be implemented in Microsoft .NET. The Web Server can be implemented using Windows 2000. The corporate data file can be a Relational Database Management System (“RDBMS”) such as Oracle.

Operations as Viewed by the User at the Client Workstation

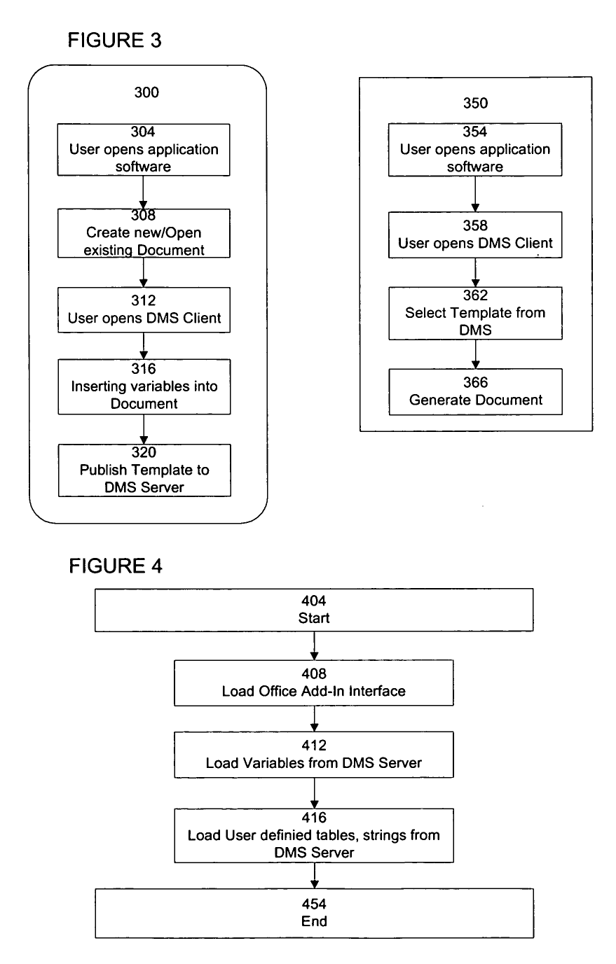

To provide context useful for understanding the details set forth below, it is useful to turn to FIG. 3 to examine the steps taken by an end-user to generate a document having embedded data values obtained from one or more corporate data files.

Unless the user is going to use a document template previously generated by another, the activities can be broken down into Step 300—Publishing a Template and Step 350 Generating a Document. Step 300 can be further subdivided into:

Step 304—User opens application software 212 on user's workstation 208. In our example this application software is Microsoft Word.

Step 308—User opens a document in the application software 212 either by creating a new document or by opening a previously saved document. The process of opening the document can be performed using the conventional commands of the application software 212.

Step 312—User opens the DMS client 204 and is presented with a set of variable names that represent various variables stored in one or more corporate data files 258. In a preferred embodiment, the variable names are names that make sense to an end-user based on what the variables represent rather than a programming nickname for the variables as used in the software that created or manages the particular corporate data file. Ideally, the variable names are gathered together in folders or otherwise arranged to facilitate finding the relevant variables among the many available variables.

Step 316—The User insert a variable name found in the open DMS client 204 into the open document in the application software 212. This step may be repeated to insert the same variable into the document in several places or to insert several different variables, possibly from two or more corporate data files into the document. These variables are just place holders for the actual values to be inserted later. In a preferred embodiment the insertion step is accomplished by a user input known as a drag and drop. This type of input is normally implemented by a computer mouse or an analogous device.

Step 320—After the User is satisfied with the document created within the application software 212 and populated with at least one variable, the user can publish the template to the DMS server.

On a subsequent day, the User can elect to generate a document as Step 350. Step 350 can be further subdivided into:

Step 354—User opens the software application 212.

Step 358—User opens the DMS client running on the user's workstation 208.

Step 362—User Selects a Template from a list of one or more templates on the DMS Server.

Step 366—The document based on the template and containing values for the variables obtained from one or more corporate data files is created.

Note that if the user wished to generate a document 350 immediately after publishing a template to the DMS server 320 then Steps 354 and 358 would not be necessary as the application software and DMS client are already open.

Operations as Viewed by the DMS System

FIG. 4 provides details on opening the DMS client 204 (See FIG. 3 Steps 312 and

These steps reflect operation under the Microsoft Windows operating system. One of ordinary skill in the art will recognize the analogous steps to initialize a DMS client that is tailored for another operating system.

Step 404 is the start of the process initiated by the user.

Step 408 Load Microsoft Office Add-in Interface including registering the menu commands; the buttons; and the Word child window(s). The Add-in Interface is an API to MS Office applications. This API allows third party programs to interact with Microsoft Office applications, show up in menus, and generally look as if third party program is built into the host application (such as for example MS Word). A Word child window in this case would be a dialog box that provides a tree view of the variables.

Step 412 Load Variables from DMS Server into TreeView Control after downloading via network communication service. In a preferred embodiment, the variables are loaded into RAM, as a linked list that, when displayed in the dialog box, is organized into the TreeView control for display to the user. TreeView is a standard Microsoft format. A TreeView type format is the format used by some browsers for example to display the relevant material through folders and subfolders. The variables could be presented to the use in a pure list such as a list sorted alphabetically. However for a list containing a large number of variables, it is useful to provide some level of organization in order to make it easier for a user to find the appropriate variable. Thus, while the description of a preferred embodiment references TreeView in a number of places, the use of TreeView is not required in order to practice the present invention.

Step 416 Load User Defined tables, strings from DMS server into TreeView Control after downloading via network communication service.

Step 454 End

Steps to Open DMS on the Server

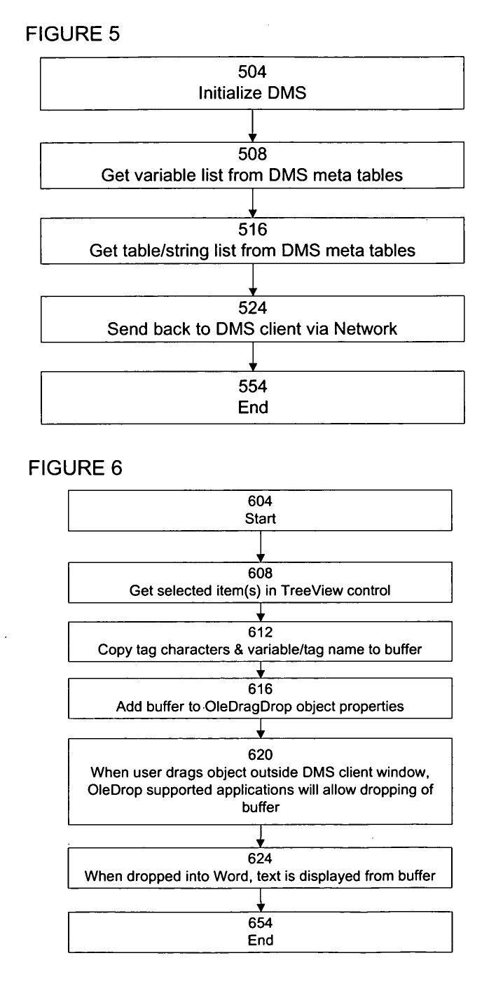

While the DMS client 204 program opens on the user's workstation 208, the DMS program on the server 250 opens. The steps are set forth in FIG. 5.

Step 504—Initialize DMS

Step 508—Get variable list from the DMS meta tables

Step 516—Get table/string list from DMS meta tables

Step 524—Send the lists to the DMS client 204 via the network

Step 554—Stop process of initializing DMS server software.

Steps for Inserting Variables and Tables Into a Template

In a preferred embodiment the insertion of variables or tables into a template is achieved through a standard drag/drop operation. FIG. 6 provides a sequence of steps to perform that operation.

Step 604—Start

Step 608—Get selected item(s) in TreeView control.

Step 612—Copy variable name to buffer. In the preferred embodiment the variable name is concatenated with another character or set of characters that distinguish the variable name from other text in the document. This is useful as the self-documenting variable names may appear indistinguishable from other relevant text unless the variable tag is marked with tag calendars. The tag characters could be places anywhere in or near the variable name. In a preferred embodiment, the tag characters are a pair of asterisks placed on the front of the variable name and a second pair placed at the end of the variable name. As discussed in the alternative embodiments section, other markers could be used in lieu of tag characters and those of skill in the art could implement the present invention without any markers beyond the variable name.

An optional but related concept is the use of a variable type prefix in the variable tag placed in the template. The prefix would come after the leading set of one or more tag characters. The prefix would provide a visual reminder to someone reviewing the template as the type of variable that will be returned. For example a prefix of “tbl” would provide a reminder that the variable tag will be replaced with a table. A prefix of “str” would provide a reminder that the variable tag will be replaced with a string that may have more than one value. The lack of a prefix can indicate that the variable tag will be replaced with a single value (a “standard variable”).

Step 616—Add buffer to OleDragDrop object properties.

Step 620—OleDragDrop supported applications will allow the user to drag the variable from the DMS client window over into the window containing the document template where the user may drop the variable into the template.

Step 624—In a preferred embodiment, when a variable tag is dropped into the template, the template shows the existence of the variable tag by displaying the variable name and the tag characters.

Sequence of Acts to Publish a Template (DMS Client)

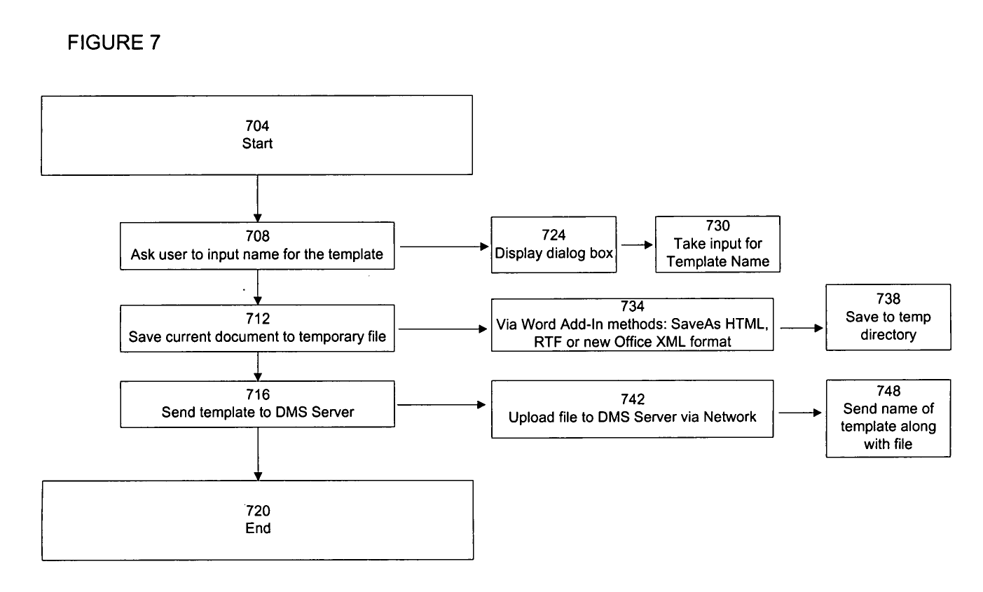

FIG. 7 provides an example of a sequence of acts to publish a template as seen at the DMS client. The sequence can be summarized as Step 704—Start; Step 708—Ask user name for template; Step 712—Save current Document to temporary file; Step 716—Send Template to DMS Server; and Step 720 End.

Step 708 is comprised of substeps Step 724—Display dialog box and Step 730—Take input for Template name.

Step 712 is comprised of substeps: Step 734—Use Word feature to save the template in a non-proprietary format such as HTML, RTF, or Office XML; and Step 738—Save the template to a temporary directory.

Step 716 is comprised of substeps: Step 742—Upload template file from temporary directory to DMS Server via Network communication service and Step 748—Send name of template along with the file.

DMS Publish Template (Server)

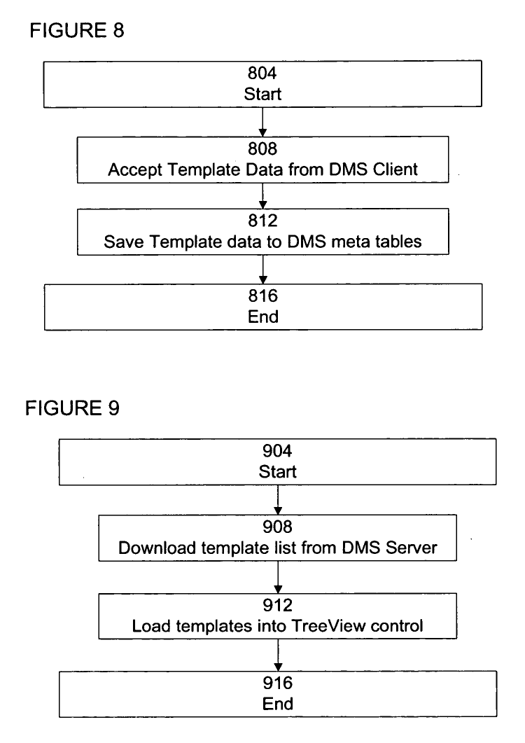

FIG. 8 provides an example of a sequence of acts to publish a template as seen at the DMS server side module. At the DMS Server, the sequence for storing a template is:

Step 804—Start

Step 808—Accept Template from DMS client via network communication service.

Step 812—Save Template data to DMS meta tables including the template buffer, template name, and template type. The template buffer is another name for the template document with the variable tags that are later replaced with values. Template types include report (a template that causes DMS to pull data from a corporate data file) and form (a template that causes DMS to push data into a corporate data file).

Step 818—End.

Steps to Display Available Templates (Client)

Turning now to FIG. 9, the steps performed by the DMS client software to display to the user the available templates are as follows:

Step 904—Start

Step 908—Download Templates from DMS Server. Note that one of ordinary skill in the art would recognize that an alternative embodiment would store the templates locally and download only the updates or additions to the templates from the DMS Server.

Step 904—Start

Step 908—Download template list from DMS server.

Step 912—Load Templates into TreeView control

Step 916—End.

Steps to Display Available Templates (Server)

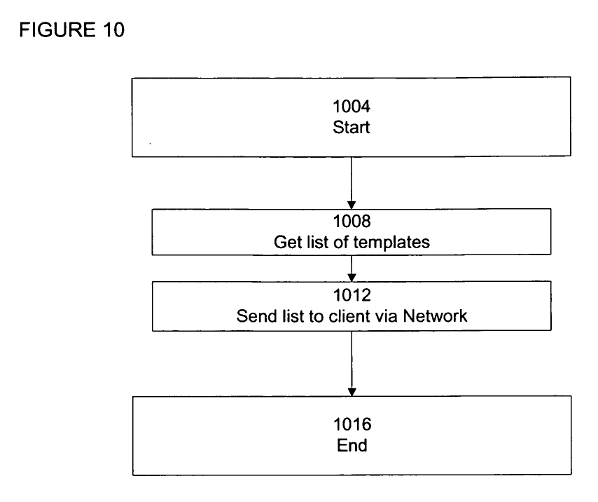

FIG. 10 conveys the steps on the server side to support the display of the list of available templates is as follows:

Step 1004—Start

Step 1008—et list of templates from DMS meta tables.

Step 1012—Send list of templates to client via network communication

Step 1016—End.

Steps for Generating a Document Based on a Specific Template and Target Data File(s)

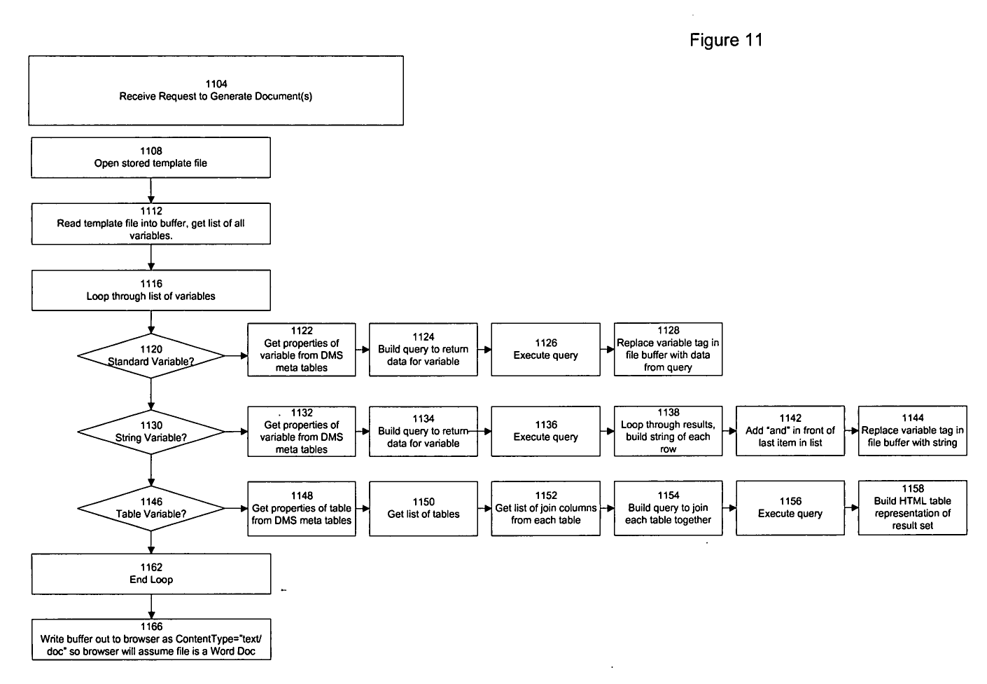

FIG. 11 illustrates one implementation of the steps for generating a document based on a specific template and set of one or more target data files. Step 1104—The Server DMS receives the request to generate a document and receives the name of the template to use and the target data files. In some implementations that process both templates for reports and templates that input data, it may be useful to pass the template type (document or input form).

Step 1108—Open Template Stored Template File

Step 1112—Read template file into buffer and create list of all variables. As noted above, the process of locating the variables can be made easier by using variable tags such as ** placed adjacent to the leading and trailing edge of the variable name text.

Step 1116—Loop through list of variables

Branch 1120—If the variable to be replaced is a standard variable, then go to Step 1122 else go to Branch 1130. In this context, “standard” means that only one value is given. Thus, a standard value could be a decimal number, an integer, a text string “Adam Ant” or some other variable type such as an image, audio file, visual file, et cetera.

Step 1122—Get properties of the standard variable from DMS meta tables.

Step 1124—Build query to obtain data for variable from target data file.

Step 1126—Execute query. Note that for a password protected corporate data file(s) such as a database, the user name and password of the user requesting the template be run to generate a document may be provided to satisfy the user ID/password requirement. Alternatively, the DMS Server itself may be given a user name and password to allow the DMS server to access files as needed to generate documents.

Step 1128—Replace variable tag in file buffer with data from query. Go to Branch 1130.

Branch 1130—If the variable to be replaced is a string variable then go to 1132 else go to Branch 1146. In this context an output “string” variable indicates that a string needs to be created from the values obtained back from the corporate data file as more than one value may be returned. Thus a “string” variable could be comprised of several integers or dates if those values are to be provided as output in the end-user's generated document as a replacement for one variable tag.

Step 1132—Get properties of string variable from DMS meta tables.

Step 1134—Build query to obtain data for variable from target data file.

Step 1136—Execute query

Step 1138—Loop through results and build a string. If there is only one returned valued, then the string is just the returned result. If there are two returned values, then the string is value 1 “and” value 2. In the more interesting case of three or more returned values, the string is comprised of a repeating sequence of value followed by an inserted comma until the last two values in the sequence which are joined by an “and” but do not have a comma trailing the final result. (some implementations may want a comma before the “and” and some may not). In a particular implementation, a loop executes against a set of values returned from a query to operate on the first through N−1 values. As each value is written to the string, a comma is added. As indicated below, after completing the N−1 th iteration, a string of “and” and the Nth returned value is inserted to replacing the last comma after the N−1 th value. Those of ordinary skill in the art will recognize that the process of converting a set of responses into a string with commas and the word “and” inserted at appropriate places can be done a variety of way using conventional programming techniques, thus the particular method of performing this step does not define the scope of the present invention.

Step 1142—Add the word “and” before the last value in the list.

Step 1144—Replace variable tag in file buffer with string built from data from data obtained by the query. Go to Branch 1146.

Branch 1146—If the next variable is a table variable then go to Step 1148, else go to Step 1162.

Step 1148—Get properties of table from DMS meta tables.

Step 1150—Get list tables . . .

Step 1152—Get list of Join Columns from each Table

Step 1154—Build Query to Join Each Table Together. Building a query that will form a table is well known to those of ordinary skill in using corporate data tools and will vary from one corporate data tool (such as SQL) to another (such as SAS or a particular CRM package).

Step 1156—Execute Query.

Step 1158—Build HTML table representation of result set.

Step 1162—End Loop. If additional variables remain, return to Step 1116, else go to 1166.

Step 1166—Write buffer out to browser. The preferred embodiment adds a file extension to mimic the output from the application program used by the end-user. For example write out a generated document to be used by the end-user in Microsoft Word with the file extension of .doc. Alternatively, the file extension could accurately reflect the underlying non-proprietary format such as RTF or HTML or other format that can be read by the end-user program. Those of ordinary skill in the art recognize that many end-user programs are not sensitive to a file extension and merely look to see if the file is of a type the program could read. For such programs, the file extension name is not critical.

Meta Tables

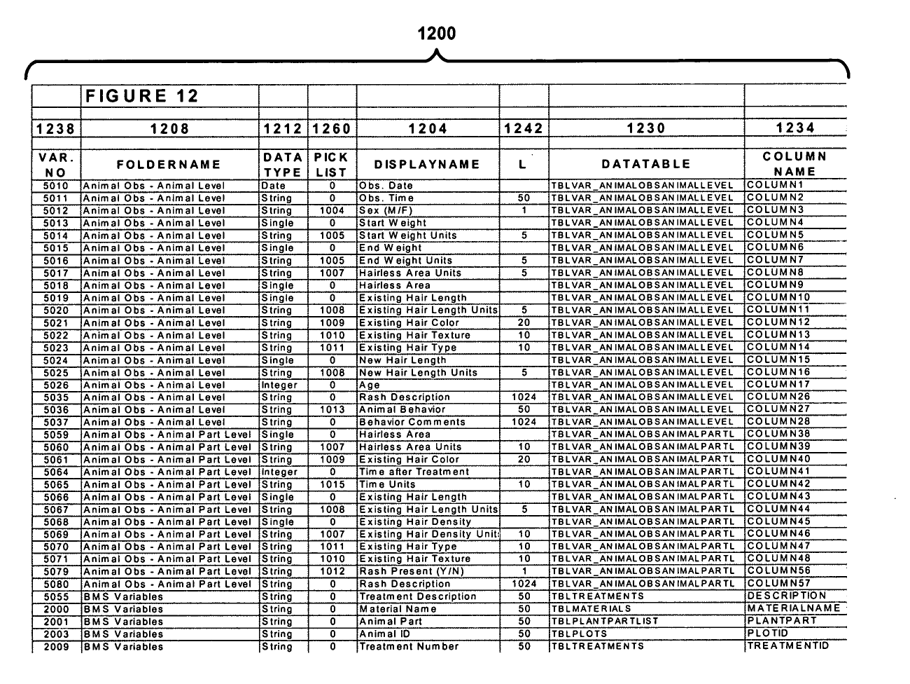

Turning now to FIG. 12, an important component of the present invention is a set of information that bridges the view of the data held by the end-user who typically does not need or want to know much beyond the user-friendly name 1204, an optional folder name 1208 for the folder where the variable is stored in a tree view of the variables, and possibly some aspects of the data type 1212 of the values stored for that variable. The end-user may also know the name of the target file for the data of interest as in the case with multiple identical tables for different: patients, scientific trials, accounting years, corporate divisions, et cetera.

In contrast the programmers for the system that stores and retrieves the corporate data need to know details such as the names for the specific table 1230 and column 1234 combination within a data base that stores the variable of interest. The programmers may also know a short name or variable number 1238 that is used to reference that variable. Further, the programmers know the data type 1212 and length 1242 as this is important for date validation and other functions.

A table such as the one shown in FIG. 12 combines both views of the data variable to allow the end-user to provide an indication to the system what variable to obtain and provides the necessary programmer type information to make obtaining information possible. (As described below, systems that allow the end-user to generate input forms also need to know the information necessary to add new values for variables into the corporate data file).

Example of a Report Template and Generated Report

Appendix B contains a report template. The report template has a series of variable tags with tag characters. Some of the variable tags also include “tbl” as a visual reminder that a table will be substituted for that particular variable tag.

The end-user can create the report template shown in Appendix B without knowledge of the specific layout of the various tables that hold the corporate data and are normally accessed through a corporate data tool. A sample set of corporate data corresponding to a portion of the Appendix B report template is also included in Appendix B. Samples of the table attributes for a table used in the report template are also included in Appendix B. Finally, a representative subset of the report that is generated when the report template is run against a particular targeted corporate data file set is also included in Appendix B.

Creation of Input Forms

As end-users are often involved with the collection and input of data that becomes the values in the corporate data files, the end-users often have special insight into the best way to arrange an input form and what text is useful to have on the form for the purpose of an explanation, reminder, or warning.

Thus, it is valuable to allow an end user to communicate a template of an input form, complete with variable tags to the access tool for creation of an electronic input form. The process of creating such as form can use the same meta table files used for creating output documents as long as the meta table includes the information necessary to complete this task.

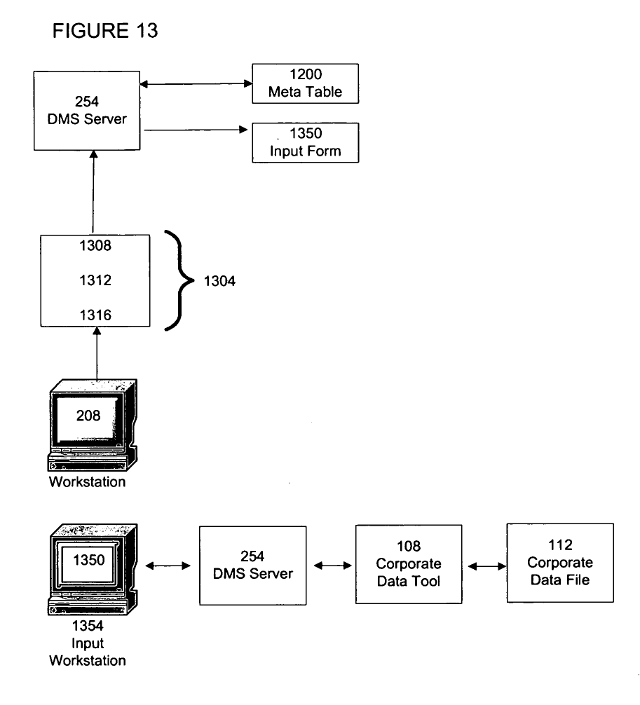

Turning now to FIGS. 12 and 13, the process for creating and using an input form can be explained as follows. An end-user, using an end-user tool such as a word processing tool lays out the text and desired locations for input on a an input form template 1304. Using the methods set forth above such as drag and drop, the end-user adds variable tags (1308, 1312, 1316) where desired on the input form template 1304. When satisfied, the input form template 1304 is submitted to the access tool, in this case the DMS server software 254. The DMS server software 254 working with the meta table 1200 for the relevant set of variables creates an input form 1350 using the text and the end-user's input form template 1304. Input form 1350 is stored for use by authorized end-users. After input form 1350 is made available, an authorized user accesses the form through the DMS Server 254 and displays the input form 1350 on Input Workstation 1354 (which may of course be workstation 208 but does not have to be). Through use of input form 1350, the inputted values are passed to DMS server software 254 which in turn uses commands for a corporate data tool 108 to insert the values in corporate data file 112.

In a preferred embodiment, pick lists 1260 are associated with some of the variables in FIG. 12. Pick lists provide a finite set of choices for a user to select while providing input to a form. Variables with a known universe of allowable values such as sex type, state (mailing address), yes/no are candidates for a pick list. Another use of a pick list is to present users with a finite set of input values make it easier to store and search for data. As indicated in FIG. 12, input choices for attributes of interest for hair are constrained by using pick lists for color, texture, and type.

Alternative Embodiments

PROTOCOL INDEPENDENCE Those of skill in the art recognize that the present invention is not dependent upon or limited to any specific protocol for the network communication from client to server as long as the concepts disclosed herein implemented with appropriate adaptations to allow for communication between the end-user computer and the computer that stores the templates and the relevant DMS program code. More specifically, the embodiments provided were described in one particular context (client server, WebServices, etc.) In order to provide substantive examples, some of the idiosyncrasies of various systems such as Microsoft Windows have bee included. These details provide context but should not be seen as a limitation or requirement that these implementation details that are platform or protocol stack dependent must be present in order for an implementation to be within the scope of the present invention.

CLIENT SERVER MODEL NOT REQUIRED The preferred embodiment for the present invention is a client server model with an end-user computer connected to a network that is connected to a server running the DMS server program. This invention does not rely on that specific topology. The application merely requires that the corporate data file be accessible and the end-user have the ability to store and retrieve templates and to access the functionality of the DMS server program such as the DMS meta tables and the execution to create a report document from a template or to load the corporate data file with data entered into a template. In a small office, the corporate data may reside in a Microsoft Excel spreadsheet on the same workstation used by the end-user to run end-user application software.

COLLECTION FORM NEED NOT BE A WEB-BASED FORM. The preferred, embodiment operates the template collection form as a web application. The template collection form could be implemented as something that could be run on a personal computer or other suitable platform so that multiple input forms could be completed and stored for upload into the corporate data file. One of skill in the art could implement the present invention across a mainframe environment so that end-users with access to certain programs through dumb terminals or computer workstations could build and store templates as described above. These templates would be used in combination with information about the data variables in the corporate data files to enable the end-users to use the tools that they are familiar with to create templates for either output documents or input forms.

NEED NOT BE “CORPORATE” DATA The data files and data controlled by the more powerful tool have been referenced as corporate data in order to clarify that the referenced data is not data under the exclusive control of the end-user. The word corporate is used to highlight that distinction. The use of the word “corporate” does not mean and should not be interpreted to mean that this invention is limited to corporate data to the exclusion of data held by a university, school, charity, religious organization, unincorporated business, partnership, or any other organization with a need to store and retrieve data using a tool that is not universally understood by all of the end-users with a need to create output document templates or input form templates.

TAG CHARACTERS ARE NOT REQUIRED The preferred embodiment of the present invention places tag characters such as ** on either side of a text string that is meant to represent a variable name. As the purpose of the tag characters is to facilitate the location of the variable names in the template, those of ordinary skill in the art will recognize that any attribute that can be readily discerned and is relatively distinctive could be used in lieu of tag characters. Examples of such markers include but are not limited to the use of an unusual font (including character font set (such as Batang or Arial Black) font size (point), font modification such as bold, italics, small caps, underline, subscript, superscript et cetera). Care must be taken when using a font modification as a user may inadvertently change the font of a section of the template and thus make the intended variable tags undetectable through use of a font clue. Various end-user tools include specific tools for marking certain sections of the document and those of skill in the art can utilize these tools in lieu of tag characters. Although not a preferred embodiment, those of skill in the art could simply parse the entire document looking for sequences of characters that match up with the list of variable names. The risk of having a set of characters (intended by the end-user as text) misinterpreted as a variable name would be reduced by the careful selection of character names such as through use of underscores, abbreviations, et cetera.

VALUES NOT LIMITED TO TEXT The returned values from the corporate data file to the document generated based on the template could include items other than text. Anything that can be stored in a computer and recalled based on an appropriate query is a viable candidate for use in the present invention. While some types of material that are stored in a computer are not suitable to be placed in a printed document (example a video clip), these non-text items may be suitable for placement in a web based document or a PowerPoint. Illustrative examples of such non-text values include images, video clips, sound files, and hyperlinks.

PLACEMENT OF VARIABLE TAGS NEED NOT BE DRAG AND DROP. While most end-users are well acquainted with the intuitive drag and drop method of placing items in an end-user file and that makes it a preferred input choice for placing variable tags, it is not essential that drag and drop be used for this purpose. Those of ordinary skill in the art are familiar with a range of tools that would allow an end-user to insert a variable tag at a specific place in a template document. Cut and paste, selection of variable tag through a series of one or more dialog boxes, are but two examples. A simpler but less user-friendly method is simply requiring the end-user to accurately type the variable tag at the desired location. Alternatively, the end-user could type some abbreviation that would be replaced by the longer variable tag through find and replace, autocorrect, or some other mechanism. Obviously, an end-user can expedite the process of building a template by modifying and saving a modified version of an existing template or by cutting and pasting sections of one or more existing templates into a new template.

QUERIES CAN BE STORED—While the preferred embodiment creates the commands needed to query the one or more corporate data files each time a template is used to generate an output document, one of skill in the art can appreciate that it may be desirable in some instances to save these queries and associate the stored queries with the template. Care would need to be taken to update the queries if the organization of the corporate data files is changed.

This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Those skilled in the art will recognize that the methods and apparatus of the present invention have many applications and that the present invention is not limited to the specific examples given to promote understanding of the present invention. Moreover, the scope of the present invention covers the range of variations, modifications, and substitutes for the system components described herein, as would be known to those of skill in the art.

The legal limitations of the scope of the claimed invention are set forth in the claims that follow and extend to cover their legal equivalents. Those unfamiliar with the legal tests for equivalency should consult a person registered to practice before the patent authority which granted this patent such as the United States Patent and Trademark Office or its counterpart.

1. A method of creating an output document in a first software program, the output document comprising text input through the use of the first software program and values stored in at least one data file accessible through second software program but not through the first software program, the method comprising:
a) storing attributes in at least one data file accessed by the third software program for a first parameter and a second parameter for parameters in the at least one data file accessed through the second software program;
b) creating a list of parameter name tags with at least one parameter name tag for the first parameter and at least one parameter name tag for the second parameter value;
c) creating a document template in the first software program;
d) inserting at least one variable tag corresponding to a parameter name tag selected from the list of parameter name tags into the document template;
e) outputting the template to a file in a format that can be edited without the use of the first software program;
f) accessing by a third software program the outputted template in the format that can be edited without the use of the first software program;
g) detecting through the use of the third software program, the first of the inserted at least one variable tags;
h) creating through use of the third software program, a set of computer commands to obtain an appropriate data value corresponding to the parameter corresponding to the first of the inserted variable tags from the at least one file accessed by the second software program;
i) accessing the at least one file through the second software program to obtain an appropriate data value corresponding to the parameter;
j) creating a file based on the outputted template in the format that can be edited outside of the first software program with the appropriate data value inserted in place of the variable tag;
k) writing the created file in a format accessible by the first software program; and
l) accessing the created file through the first software program to obtain the output document containing the appropriate data value in place of the inserted variable tag;
whereby a user can control the placement of the at least one variable tag into the document template created in the first program and obtain the output document containing the appropriate data value for the corresponding parameter in place of the inserted first of at least one variable tag without the user directly entering any data retrieval requests through the second software program.

2. The method of claim 1 wherein the third software program is the same as the second software program but the third software program is not the same as the first software program.

3. The method of claim 1 wherein:
the step of inserting at least one variable tag into the document template includes concatenating the parameter name tag with at least one tag character; and
the step of detecting through the use of the third software program, the first of the inserted variable tag in the outputted template comprises an effort to locate the presence of the at least one tag character.

4. The method of claim 1 wherein the step of detecting through the use of the third software program, the first of the inserted at least one variable tags in the outputted template comprises an effort to locate a tag marker.

5. The method of claim 4 wherein the tag marker comprises the use of a font reserved for use with variable tags.

6. The method of claim 1 wherein the step of detecting through the use of the third software program, the first of the inserted at least one variable tags in the outputted template comprises an effort to locate a text string corresponding to at least a section of one of the parameter name tags.

7. The method of claim 1 wherein the step of inserting at least one variable tag corresponding to the parameter name tag selected from the list of parameter name tags into the document template is performed by dragging a representation of a parameter name tag from the list of parameter name tags and dropping the representation into a desired position within the template.

8. The method of claim 1 wherein the step of creating a document template in the first software program comprises opening a document accessible through the first software program and modifying the opened document to create the document template.

9. The method of claim 1 wherein the third software program is distributed between a client module of the third software program and a server module of the third software program wherein the list of parameter name tags is stored on a server remote from a client computer and made available so that templates created on the client computer can insert at least one variable tag corresponding to a selected parameter name tag from the list of parameter name tags into the document template.

10. The method of claim 1 wherein the set of computer commands to obtain the appropriate data value corresponding to the parameter corresponding to the first of the inserted variable tags is stored such that subsequent uses of the outputted template can be performed without creating anew this set of computer commands.

11. The method of claim 1 further comprising the step of
Creating through use of the third software program, a second set of computer commands to obtain an appropriate data value corresponding to the parameter corresponding to the second of the inserted variable tags from the at least one file accessed by the second software program whereby two queries are executed to obtain the data value for the parameters associated with the first and second variable tags.

12. The method of claim 1 wherein:
the step of accessing the at least one file through the second software program to obtain an appropriate data value corresponding to the parameter yields at least three values which were separate entries in the at least one data file accessed by the second computer program; and
the step of creating the file based on the outputted template in the format that can be edited outside of the first software program with the appropriate data value inserted in place of the variable tag includes the sub-step of combining the at least three values into a string with the addition of at least one comma and an “and” inserted into the string.

13. A method of creating an output document in a first software program, the output document comprising text input through the use of the first software program and at least one value stored in at least one data file accessible through second software program but not through the first software program and at least one value stored in at least one data file accessible through a fourth software program, different from the second software program, the at least one data file accessible through the fourth software program not accessible through the first software program, the method comprising:
a) storing attributes in at least one data file accessed by the third software program for a first parameter and a second parameter for parameters in the at least one data file accessed through the second software program;
b) creating a list of parameter name tags with at least one parameter name tag for the first parameter and at least one parameter name tag for the second parameter value;
c) creating a document template in the first software program;
d) inserting at least one variable tag corresponding to a parameter name tag selected from the list of parameter name tags into the document template;
e) outputting the template to a file in a format that can be edited without the use of the first software program;
f) accessing by a third software program the outputted template in the format that can be edited without the use of the first software program;
g) detecting through the use of the third program, the first of the inserted at least one variable tags;
h) creating through use of the third program, a set of computer commands to obtain an appropriate data value corresponding to the first parameter corresponding to the first of the inserted variable tags from the at least one file accessed by the second software program;
i) detecting through the use of the third program, the second of the inserted at least one variable tags;
j) creating through use of the third program, a set of computer commands to obtain an appropriate data value corresponding to the second parameter corresponding to the second of the inserted variable tags from the at least one file accessed by the fourth software program;
k) accessing the at least one file through the second software program to obtain an appropriate data value corresponding to the first parameter;
l) accessing the at least one file through the fourth software program to obtain an appropriate data value corresponding to the second parameter;
m) creating a file based on the outputted template in the format that can be edited outside of the first software program with the appropriate data values inserted in place of the first variable tag and in place of the second variable tag;
n) writing the created file in a format accessible by the first software program; and
o) accessing the created file through the first software program to obtain the output document containing the appropriate data values in place of the inserted first and second variable tags;
whereby a user can control the placement of variable tags into the document template created in the first program and obtain the output document containing the appropriate data values for the corresponding parameters in place of the inserted variable tags without the user directly entering any data retrieval requests through the second computer program and without the user directly entering any data retrieval requests through the fourth computer program.

14. A method of creating an input screen created by a third program based on an input form template from a first software program, the input screen for receiving input values for entry into at least one data file accessed through a second computer program, the method comprising:
a) storing attributes in at least one data file accessed by the third software program for a first parameter and a second parameter for parameters in at least one data file accessed through the second software program;
b) creating a list of parameter name tags with at least one parameter name tag for the first parameter and at least one parameter name tag for the second parameter value;
c) creating the input form template in the first software program;
d) inserting at least one variable tag corresponding to a parameter name tag selected from the list of parameter name tags into the input form template;
e) writing the input form template to a file in a format that can be read without the use of the first software program;
f) accessing by a third software program the input form template in the format that can be read without the use of the first software program;
g) detecting through the use of the third program, the first of the inserted at least one parameter name tags;
h) creating through use of the third program, the input screen based on the input form template with each variable tag replaced by an input field suitable to receive input of an appropriate data value for the parameter corresponding to each of the inserted variable tags; and
i) making the completed input screen accessible to a least one user so the user can provide input values into the input fields for entry into the corporate data file.

15. The method of claim 14 wherein a pick list is associated with at least one parameter and the pick list association is stored as an attribute associated with that parameter such that the step of creating in the input screen comprises the automatic replacement of the variable tag associated with that parameter with a pick list input dialog that constrains the input to the selection of one of an enumerated list of choices for that pick list.

16. The method of claim 14 wherein the stored attributes for the first parameter are used by the third program to perform data validation checks before allowing input from the user to be submitted for inclusion in the set of at least one data file accessed through the second program.

17. The method of claim 14 wherein the third software program is the same as the second software program but the third software program is not the same as the first software program.

18. The method of claim 14 wherein:
the step of inserting at least one variable tag into the document template includes concatenating the parameter name tag with at least one tag character; and
the step of detecting through the use of the third program, the first of the inserted variable tag in the outputted template comprises an effort to locate the presence of the at least one tag character.

19. The method of claim 14 wherein
the step of detecting through the use of the third program, the first of the inserted at least one variable tags in the outputted template comprises an effort to locate a tag marker.
